(19) United States
(12) Patent Application Publication
(10) Pub. No.: US 2003/0012422 A1
(43) Pub. Date: Jan. 16, 2003

(54) Method of recognizing pattern side face and method of detecting and classifying defects

(75) Inventors: Kouetsu Sawai, Tokyo (JP); Masahiko Ikeno, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, TOKYO (JP)

(21) Appl. No.: 10/109,668

(22) Filed: Apr. 1, 2002

(30) Foreign Application Priority Data
Jul. 13, 2001 (JP) 2001-213713

(51) Int. Cl. G06K 9/00

(52) U.S. Cl. 382/149

(57) ABSTRACT

A width (25) of a side-face image of a pattern top layer to be found in an SEM image (d) obtained by review with a wafer (3) tilted can be calculated from the actual thickness of the pattern top layer and the tilt angle of the wafer (3). An auto defect review/classification system detects an image having the same width as the calculated value, to recognize an image (22) to be a side-face image of the pattern top layer. Further, if the side-face image (22) of the pattern top layer is found, it is recognized that an image (23) therebelow should be a side-face image of a pattern second layer. By recognizing the images of the respective layers in the pattern, it becomes possible to specify a layer in which a detected defect lies in defect detection performed later. Thus, from an SEM image of the wafer on which a pattern of single-layer or multilayer structure is formed, the pattern side face and the images of the respective layers in the pattern, and further the layer in which a defect lies can be automatically recognized.

### BACKGROUND OF THE INVENTION

1. Field of the Invention

The present invention relates to an auto defect review and an auto defect classification in a process of manufacturing a semiconductor device, and more particularly to a technique to automatically detect and classify defects of a pattern formed on a wafer from an SEM image of a side face of the pattern.

2. Description of the Background Art

In order to increase yields in a process of manufacturing a semiconductor device and improve the process, it is important to know a process step in which a defect is developed in a process of forming patterns such as interconnection on a semiconductor wafer. In the background art, to track the process step in which the defect is developed, a research on pattern defects is carried out and a review is performed by a scanning electron microscope (SEM) on the basis of coordinate data obtained as the research result.

Further, in recent years, an SEM system having ADR (Auto Defect Review) and ADC (Auto Defect Classification) functions (hereinafter, referred to as an “auto defect review/classification system”) has been used to track the process step in which the defect is developed, thereby increasing yields and improving the manufacturing process.

In the background-art auto defect review/classification system using an SEM, a review on a wafer is basically performed from a vertical direction, and when the pattern on the wafer has a multilayer structure consisting of a plurality of layers, it is very difficult to automatically detect defects developed in a process of forming lower layers of the pattern.

In other words, to automatically detect the defects developed in the process of forming the lower layers of the pattern by the auto defect review/classification system using the SEM, a review on a side face of the pattern effectively works. For the review of the pattern side face, it is necessary for the system to automatically recognize a side-face image of the pattern (a side-face image of each layer in the pattern of multilayer structure) in an obtained SEM image.

### SUMMARY OF THE INVENTION

The present invention is directed to a method of recognizing a pattern side face. According to a first aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining an SEM image in a state where the wafer is tilted at a predetermined angle; calculating the width of a side-face or upper-face image of a predetermined layer in the single-layer or multilayer structure to be found in the SEM image, from the predetermined angle and the thickness of a side face or the width of an upper face of the predetermined layer; detecting an image having a width which corresponds to the calculated width in the SEM image to detect the side-face or upper-face image of the predetermined layer in the SEM image; and recognizing a side-face image of each layer of the single-layer or multilayer structure in the SEM image on the basis of the position of the side-face or upper-face image of the predetermined layer which is detected.

According to a second aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining an SEM image in a state where the wafer is tilted at a predetermined angle; calculating the brightness of a side-face or upper-face image of a predetermined layer in the single-layer or multilayer structure to be found in the SEM image, from the predetermined angle and the material of the predetermined layer; detecting an image having a brightness which corresponds to the calculated brightness in the SEM image to detect the side-face or upper-face image of the predetermined layer in the SEM image; and recognizing a side-face image of each layer of the single-layer or multilayer structure in the SEM image on the basis of the position of the side-face or upper-face image of the predetermined layer which is detected.

According to a third aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining an SEM image in a state where the wafer is tilted at a predetermined angle; transforming CAD data of the pattern on the basis of the predetermined angle; superimposing the transformed CAD data on the SEM image to detect an upper-face image of the pattern in the SEM image; and recognizing a side-face image of each layer of the single-layer or multilayer structure in the SEM image on the basis of the position of the upper-face image of the pattern which is detected.

According to a fourth aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining a first SEM image in a state where the wafer is tilted at a predetermined angle; obtaining a second SEM image in a state where the wafer is not tilted; transforming the second SEM image on the basis of the predetermined angle; superimposing the transformed second SEM image on the first SEM image to detect an upper-face image of the pattern in the first SEM image; and recognizing a side-face image of each layer of the single-layer or multilayer structure in the first SEM image on the basis of the position of the upper-face image of the pattern which is detected.

According to a fifth aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining a first SEM image in a state where the wafer is tilted at a first angle; obtaining a second SEM image in a state where the wafer is tilted at a second angle; comparing the first SEM image with the second SEM image to detect upper-face and side-face images of the pattern in the first and second SEM images from increase and decrease in brightness of the first and second images; and recognizing a side-face image of each layer of the single-layer or multilayer structure in the first and second SEM images on the basis of the positions of the upper-face and side-face images of the pattern which is detected.

According to a sixth aspect of the present invention, the method of recognizing a pattern side face, using an SEM image of a wafer which has a pattern of single-layer or multilayer structure in its surface, for recognizing a side-face image of each layer of the single-layer or multilayer structure in the SEM image, comprises the steps of: obtaining a first SEM image in a state where the wafer is tilted at a first angle; obtaining a second SEM image in a state where the wafer is tilted at a second angle; comparing the first SEM image with the second SEM image to detect upper-face and side-face images of the pattern in the first and second SEM images from increase and decrease in length and area of the first and second images; and recognizing a side-face image of each layer of the single-layer or multilayer structure in the SEM image on the basis of the positions of the upper-face and side-face images of the pattern which is detected.

According to a seventh aspect of the present invention, the method of recognizing a pattern side face is any one of the methods according to the first to sixth aspects, and the method of the seventh aspect further comprises the step of changing an accelerating voltage of electron beams in an SEM to obtain an SEM image again when the difference in brightness of images of the wafer and layers of the single-layer or multilayer structure in the SEM image is not detected.

According to an eighth aspect of the present invention, the method of recognizing a pattern side face is any one of the methods according to the first to sixth aspects, and the method of the eighth aspect further comprises the step of changing a tilt angle of the wafer to obtain an SEM image again when the difference in brightness of images of the wafer and layers of the single-layer or multilayer structure in the SEM image is not detected.

The present invention is also directed to a method of detecting and classifying a defect. According to a ninth aspect of the present invention, the method of detecting and classifying a defect, for detecting a defect in a pattern of single-layer or multilayer structure on a wafer and making a classification by specifying which one of layers in the pattern includes the defect, comprises the steps of: obtaining an SEM image in a state where the wafer is tilted at a predetermined angle; recognizing a side-face image of each layer of the single-layer or multilayer structure in the SEM image by using a predetermined method; recognizing at least an upper contour of the recognized side-face image of each layer of the single-layer or multilayer structure; and detecting deformation of the upper contour of the side-face image of each layer of the single-layer or multilayer structure to detect the defect and make a classification by specifying which one of layers in the pattern includes the defect.

According to a tenth aspect of the present invention, the method of detecting and classifying a defect, for detecting a defect in a pattern of single-layer or multilayer structure on any chip of a wafer having a plurality of chips and making a classification by specifying which one of layers in the pattern includes the defect, comprises the steps of: obtaining an SEM image in a state where the wafer is tilted at a predetermined angle; recognizing a side-face image of each layer of the single-layer or multilayer structure in the SEM image by using a predetermined method; and comparing the brightness of images of layers in the pattern of the plurality of chips in the SEM image to detect the defect and make a classification by specifying which one of layers in the pattern includes the defect.

According to an eleventh aspect of the present invention, the method of detecting and classifying a defect is any one of the methods according to the ninth and tenth aspects, and the predetermined method in the step for recognizing a side-face image of each layer of the single-layer or multilayer structure in the SEM image is the method of recognizing a pattern side face according to any one of the first to eighth aspects.

Since the method of recognizing a pattern side face of the first aspect comprises the steps of obtaining an SEM image in a state where the wafer is tilted at a predetermined angle; calculating the width of a side-face or upper-face image of a predetermined layer in the single-layer or multilayer structure to be found in the SEM image, from the predetermined angle and the thickness of a side face or the width of an upper face of the predetermined layer; detecting an image having a width which corresponds to the calculated width in the SEM image to detect the side-face or upper-face image of the predetermined layer in the SEM image; and recognizing a side-face image of each layer of the single-layer or multilayer structure in the SEM image on the basis of the position of the side-face or upper-face image of the predetermined layer which is detected in the SEM image, it is possible to recognize the side face of each layer of the pattern in the SEM image.

Further, by storing the tilt angle of the wafer and the thickness of the side face or the width of the upper face of the predetermined layer, or the width of the side-face or upper-face image of the predetermined layer to be found in said SEM image which is calculated from the tilt angle and the thickness of the side face or the width of the upper face into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the second aspect comprises the steps of obtaining an SEM image in a state where the wafer is tilted at a predetermined angle; calculating the brightness of a side-face or upper-face image of a predetermined layer in the single-layer or multilayer structure to be found in the SEM image, from the predetermined angle and the material of the predetermined layer; detecting an image having a brightness which corresponds to the calculated brightness in the SEM image to detect the side-face or upper-face image of the predetermined layer in the SEM image; and recognizing a side-face image of each layer of the single-layer or multilayer structure in the SEM image on the basis of the position of the side-face or upper-face image of the predetermined layer which is detected in the SEM image, it is possible to recognize the side face of each layer of the pattern in the SEM image.

Further, by storing the brightness of the side-face or upper-face image of the predetermined layer to be found in said SEM image, which is calculated from the tilt angle of the wafer and the material of said predetermined layer into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the third aspect comprises the steps of obtaining an SEM image in a state where the wafer is tilted at a predetermined angle; transforming CAD data of the pattern on the basis of the predetermined angle; superimposing the transformed CAD data on the SEM image to detect an upper-face image of the pattern in the SEM image; and recognizing a side-face image of each layer of the single-layer or multilayer structure in the SEM image on the basis of the position of the upper-face image of the pattern which is detected, it is possible to recognize the side face of each layer of the pattern in the SEM image.

Further, by storing the CAD data of the pattern into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the fourth aspect comprises the steps of obtaining a first SEM image in a state where the wafer is tilted at a predetermined angle; obtaining a second SEM image in a state where the wafer is not tilted; transforming the second SEM image on the basis of the predetermined angle; superimposing the transformed second SEM image on the first SEM image to detect an upper-face image of the pattern in the first SEM image; and recognizing a side-face image of each layer of the single-layer or multilayer structure in the first SEM image on the basis of the position of the upper-face image of the pattern which is detected, it is possible to recognize the side face of each layer of the pattern in the SEM image.

Further, without storing the data and the like for recognizing the pattern side face into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the fifth aspect comprises the steps of obtaining a first SEM image in a state where the wafer is tilted at a first angle; obtaining a second SEM image in a state where the wafer is tilted at a second angle; comparing the first SEM image with the second SEM image to detect upper-face and side-face images of the pattern in the first and second SEM images from increase and decrease in brightness of the first and second images; and recognizing a side-face image of each layer of the single-layer or multilayer structure in the first and second SEM images on the basis of the positions of the upper-face and side-face images of the pattern which is detected, it is possible to recognize the side face of each layer of the pattern in the SEM image.

Further, without storing the data and the like for recognizing the pattern side face into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the sixth aspect comprises the steps of obtaining a first SEM image in a state where the wafer is tilted at a first angle; obtaining a second SEM image in a state where the wafer is tilted at a second angle; comparing the first SEM image with the second SEM image to detect upper-face and side-face images of the pattern in the first and second SEM images from increase and decrease in length and area of the first and second images; and recognizing a side-face image of each layer of the single-layer or multilayer structure in the SEM image on the basis of the positions of the upper-face and side-face images of the pattern which is detected, it is possible to recognize the side face of each layer of the pattern in the SEM image.

Further, without storing the data and the like for recognizing the pattern side face into the auto defect review/classification system in advance, the auto defect review/classification system can automatically detect the pattern side face in the SEM image. Furthermore, this contributes to automation of the defect detection/classification method by the auto defect review/classification system.

Since the method of recognizing a pattern side face of the seventh aspect further comprises the step of changing an accelerating voltage of electron beams in an SEM to obtain an SEM image again when the difference in brightness of images of the wafer and layers of the single-layer or multilayer structure in the SEM image is not detected by the method of recognizing a pattern side face according to any one of the first to sixth aspects, the difference in brightness of the images of the wafer and the respective layers is clarified and the auto defect review/classification system can perform the automatic recognition of the pattern side face with high accuracy. Further, this contributes to automation of the defect detection/classification method by the auto defect review/classification system.

Since the method of recognizing a pattern side face of the eighth aspect further comprises the step of changing a tilt angle of the wafer to obtain an SEM image again when the difference in brightness of images of the wafer and layers of the single-layer or multilayer structure in the SEM image is not detected by the method of recognizing a pattern side face according to any one of the first to sixth aspects, the difference in brightness of the images of the wafer and the respective layers is clarified and the auto defect review/classification system can perform the automatic recognition of the pattern side face with high accuracy. Further, this contributes to automation of the defect detection/classification method by the auto defect review/classification system.

Since the method of detecting and classifying a defect of the ninth aspect comprises the steps of obtaining an SEM image in a state where the wafer is tilted at a predetermined angle; recognizing a side-face image of each layer of the single-layer or multilayer structure in the SEM image by using a predetermined method; recognizing at least an upper contour of the recognized side-face image of each layer of the single-layer or multilayer structure; and detecting deformation of the upper contour of the side-face image of each layer of the single-layer or multilayer structure to detect the defect and make a classification by specifying which one of layers in the pattern includes the defect, it is possible to detect the defect and specify the layer in which the defect lies and this contributes to increase yields in a process of manufacturing a semiconductor device and improve the process.

Further, the auto defect review/classification system recognizes the side-face image of each layer of the single-layer or multilayer structure in the SEM image, and the auto defect review/classification system can thereby automatically detect and classify the defect when the defect causes deformation of the upper face of the layer.

Since the method of detecting and classifying a defect of the tenth aspect comprises the steps of obtaining an SEM image in a state where the wafer is tilted at a predetermined angle; recognizing a side-face image of each layer of the single-layer or multilayer structure in the SEM image by using a predetermined method; and comparing the brightness of images of layers in the pattern of the plurality of chips in the SEM image to detect the defect and make a classification by specifying which one of layers in the pattern includes the defect, it is possible to detect the defect and specify the layer in which the defect lies and this contributes to increase yields in a process of manufacturing a semiconductor device and improve the process.

Further, the auto defect review/classification system recognizes the side-face image of each layer of the single-layer or multilayer structure in the SEM image, and the auto defect review/classification system can thereby automatically detect and classify the defect only if the image of defect is found in the SEM image even when the defect does not cause deformation of the upper face of the layer.

In the method of detecting and classifying a defect of the eleventh aspect, since the predetermined method in the step of recognizing the side-face image of each layer of the single-layer or multilayer structure in the SEM image in the method of detecting and classifying a defect according to the ninth or tenth aspect is the method of recognizing a pattern side face according to any one of the first to eighth aspects, the process of recognizing the side-face image of each layer of the single-layer or multilayer structure in the SEM image can be automated in the automatic detection and classification of defects by the auto defect review/classification system and therefore it becomes possible to perform the automatic detection and classification of defects by the auto defect review/classification system.

A first object of the present invention is to provide a method of recognizing a pattern side face for automatic recognition of a side face of each layer in a pattern of single-layer or multilayer structure formed on a wafer in an auto defect review/classification system using an SEM. A second object of the present invention is to provide a method of detecting and classifying a defect for detecting a defect in the pattern and making a classification by specifying which one of layers in the pattern includes the defect.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1D are views showing a method of recognizing a pattern side face in accordance with a first preferred embodiment of the present invention;

FIG. 2 is a view showing a method of recognizing a pattern side face in accordance with a second preferred embodiment of the present invention;

FIGS. 3A to 3C are views illustrating a method of recognizing a pattern side face in accordance with a third preferred embodiment of the present invention;

FIGS. 4A to 4C are views illustrating a method of recognizing a pattern side face in accordance with a fourth preferred embodiment of the present invention;

FIG. 5 is a view illustrating a method of recognizing a pattern side face in accordance with a fifth preferred embodiment of the present invention;

FIGS. 6A and 6B are views illustrating a method of recognizing a pattern side face in accordance with a sixth preferred embodiment of the present invention;

FIG. 7 is a view illustrating a method of detecting and classifying defects in accordance with a seventh preferred embodiment of the present invention;

FIG. 8 is a view illustrating a method of detecting and classifying defects in accordance with an eighth preferred embodiment of the present invention;

FIGS. 9A and 9B are views illustrating a method of recognizing a pattern side face in accordance with a ninth preferred embodiment of the present invention; and

FIGS. 10A and 10B are views illustrating a method of recognizing a pattern side face in accordance with a tenth preferred embodiment of the present invention.

### DESCRIPTION OF THE PREFERRED EMBODIMENTS

<The First Preferred Embodiment>

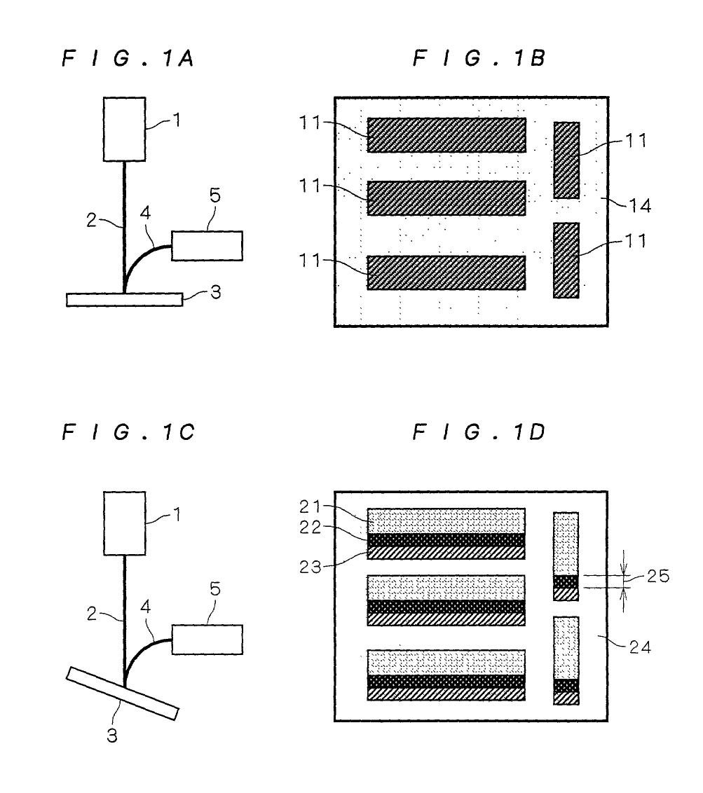

FIGS. 1A to 1D are views illustrating a method of recognizing a pattern side face in accordance with the first preferred embodiment of the present invention. Specifically, FIG. 1A shows the relation of angle between an electron beam of a scanning electron microscope (SEM) and a wafer to be reviewed when the wafer is not tilted, and FIG. 1B shows an exemplary SEM image obtained in the case of FIG. 1A. Further, FIG. 1C shows the relation of angle between the electron beam of the SEM and the wafer to be reviewed when the wafer is tilted, and FIG. 1D shows an exemplary SEM image obtained from the same wafer as shown in FIG. 1B in the case of FIG. 1C. In the present description, as to the tilt angle of wafer, the state shown in FIG. 1A is defined as 0 degree.

FIGS. 1A and 1C show an electron gun 1 of the SEM, an electron beam 2 emitted from the electron gun 1, a wafer 3 to be reviewed by the SEM, a secondary electron 4 emitted from the wafer 3 by irradiation of the electron beam 2 and a secondary-electron detector 5 of the SEM.

FIGS. 1B and 1D show a case where patterns formed on the wafer 3 each have a double-layer structure consisting of two layers, i.e., a pattern top layer and a pattern second layer therebelow. Since the wafer is reviewed from a vertical direction when not tilted, FIG. 1B showing the SEM image in the case where the wafer is not tilted presents upper faces of the patterns formed on the wafer 3, i.e., upper-face images 11 of the pattern top layers and an image 14 of a surface of the wafer 3.

On the other hand, FIG. 1D showing the SEM image when the wafer is tilted presents upper-face images 21 of the pattern top layers, side-face images 22 of the pattern top layers, side-face images 23 of the pattern second layers and an image 24 of the surface of the wafer 3. Specifically, since the electron beam 2 is also irradiated to the side faces of the patterns by tilting the wafer 3, the side-face images of the patterns (the side-face images 22 of the pattern top layers and the side-face images 23 of the pattern second layers), which are not found in the SEM image (of FIG. 1B) obtained by reviewing the wafer 3 from the vertical direction, can be found in FIG. 1D. Reference numeral 25 of FIG. 1D represents the width of the side-face image 22 of the pattern top layer in the SEM image.

A method of recognizing a pattern side face in accordance with the first preferred embodiment will be discussed below. First, a value to be obtained as a width 25 of the side-face image of the pattern top layer in the SEM image when the wafer is tilted at a predetermined angle is stored in an SEM system having the ADR/ADC function (auto defect review/classification system) in advance. The width 25 of the side-face image of the pattern top layer can be calculated from the thickness of the pattern top layer and the tilt angle of the wafer in the review by the SEM. For example, when the thickness of the pattern top layer is 1 μm and the tilt angle of the wafer is 30 degrees, the width 25 of the side-face image of the pattern top layer to be reviewed on a screen of the SEM can be obtained by calculation as 1 μm×sin 30°=0.5 μm. Further, the thickness of the pattern top layer used in this calculation may be a value obtained by actual measurement of other devices or a value which is set in designing patterns.

Then, an SEM image of the wafer is obtained by review with the wafer tilted at the predetermined angle. At this time, the auto defect review/classification system compares the width of each pattern image in the obtained SEM image with the stored value which should be obtained as the width 25 of the side-face image of the pattern top layer, to detect an image having the same width as the stored value in the obtained SEM image. As a result, the auto defect review/classification system can recognize that the image 22 on the SEM screen should be the side-face image of the pattern top layer. Further, recognizing the side-face image 22 of the pattern top layer, the auto defect review/classification system can recognize that the image 23 therebelow should be the side-face image of the pattern second layer.

Further, though the value indicating the width 25 of the side-face image of the pattern top layer obtained by calculation using the thickness of the pattern top layer and the tilt angle of the wafer in the review is stored into the auto defect review/classification system in the above case, there may be a case where a value indicating the thickness of the pattern top layer is stored into the auto defect review/classification system and the auto defect review/classification system detects the tilt angle of the wafer and calculates a value to be obtained as the width 25 of the side-face image of the pattern top layer.

Furthermore, though the first preferred embodiment shows the case where the pattern which has the double-layer structure consisting of the pattern top layer and the pattern second layer is formed as a pattern on the wafer to be reviewed, even in a pattern consisting of more layers, by finding the position of the side face of the pattern top layer, it is possible to recognize side-face images of lower layers on the basis of the position. In other words, the application range of the first preferred embodiment is not limited to the pattern having the double-layer structure.

Moreover, though the side-face image 22 of the pattern top layer is first recognized and then the side-face images of other layers are detected and recognized on the basis thereof in the first preferred embodiment, the basis of detection is not limited to the side-face image 22 of the pattern top layer. For example, it is possible to recognize the upper-face image 21 of the pattern top layer in the SEM image obtained in the review with the wafer tilted from the width of the upper face of the pattern top layer and the tilt angle of the wafer and the side-face images of the lower layers in the pattern can be detected on the basis of the upper-face image 21. There may be another case where the side-face image of the pattern second layer is recognized from the thickness of the pattern second layer and the tilt angle of the wafer and the side-face images of respective layers in the pattern are detected on the basis thereof.

In short, the method of recognizing a pattern side face in accordance with the first preferred embodiment allows the auto defect review/classification system to automatically detect the pattern side face in the SEM image by storing the width of a predetermined image obtained by calculation using size data of the pattern and the tilt angle of the wafer in the review by the SEM into the auto defect review/classification system.

<The Second Preferred Embodiment>

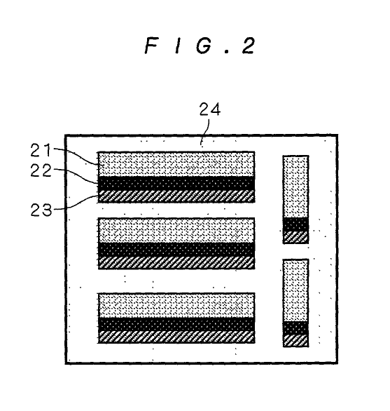

FIG. 2 is a view illustrating a method of recognizing a pattern side face in accordance with the second preferred embodiment of the present invention, showing an SEM image obtained in a review with a wafer tilted. Further, in FIG. 2, the same constituent elements as those in FIG. 1D are represented by the same reference numerals and detailed description on these elements will be omitted herein. Furthermore, FIG. 2 also shows the case where the patterns each of which has double-layer structure consisting of the pattern top layer and the pattern second layer are formed on a surface of the wafer.

The brightness of each pattern image in the SEM image depends on the amount of secondary electrons emitted from a surface of a sample by irradiation of electron beams, and the amount of emitted secondary electrons depends on an angle of the sample surface to the electron beams and a material of the sample. For example, in FIG. 2, since the upper face and the side face in the same pattern top layer are different from each other in angle to the electron beams, the upper-face image 21 of the pattern top layer and the side-face image 22 of the pattern top layer are different from each other in brightness. Further, though the side face of the pattern top layer and the side face of the pattern second layer have the same angle to the electron beams, the side-face image 22 of the pattern top layer and the side-face image 23 of the pattern second layer are different from each other in brightness due to the difference of their materials.

Therefore, the image of the wafer and the images of respective portions of the pattern in the SEM image are different from one another in brightness as shown in FIG. 2. This suggests that recognition of pattern side face can be made on the basis of the difference in brightness of respective images in the SEM image.

A method of recognizing a pattern side face in accordance with the second preferred embodiment will be discussed below. First, a value of brightness to be obtained with respect to the side-face image 22 of the pattern top layer in the SEM image when the wafer is tilted at a predetermined angle is stored into the auto defect review/classification system in advance.

The value of brightness to be obtained with respect to the side-face image 22 of the pattern top layer for being stored in the auto defect review/classification system can be calculated from e.g., measurement data obtained by reviewing a sample made of the same material as that of the pattern top layer by the SEM in advance at the same incident angle of the electron beams as that to be used in the review performed thereafter by the SEM.

Then, an SEM image of the wafer is obtained by review with the wafer tilted at the predetermined angle. At this time, the auto defect review/classification system detects an image having the same value of brightness as the stored value of brightness with respect to the side-face image 22 of the pattern top layer in the obtained SEM image. As a result, the auto defect review/classification system can recognize that the image 22 on the SEM screen should be the side-face image of the pattern top layer. Further, recognizing the side-face image 22 of the pattern top layer, the auto defect review/classification system can recognize that the image 23 therebelow should be the side-face image of the pattern second layer.

It is assumed, for example, that the brightness in the SEM image is represented by 256-level white and black. In this case, when it is known that the brightness of the side-face image 22 of the pattern top layer ranges from 80-level tone to 120-level tone in the review with wafer tilted at a predetermined angle, by storing the level-tone range into the auto defect review/classification system in advance, the auto defect review/classification system can detect a portion having a brightness (tone in this case) within the range and recognize that the image 22 in the SEM image should be the side face of the pattern top layer and the side face of the pattern second layer.

Further, though the second preferred embodiment shows the case where the pattern which has the double-layer structure consisting of the pattern top layer and the pattern second layer is formed as a pattern on the wafer to be reviewed, even in a pattern consisting of more layers, by finding the position of the side face of the pattern top layer, it is possible to recognize side-face images of lower layers on the basis of the position. In other words, the application range of the second preferred embodiment is not limited to the pattern having the double-layer structure.

Moreover, though the side-face image 22 of the pattern top layer is first recognized and then the side-face images of other layers are detected and recognized on the basis thereof in the second preferred embodiment, the basis of detection is not limited to the side-face image 22 of the pattern top layer. For example, it is possible to recognize the upper-face image 21 of the pattern top layer in the SEM image from a value of brightness to be obtained with respect to the upper-face image 21 of the pattern top layer and the side-face image of the pattern can be detected on the basis of the upper-face image 21. There may be another case where the side-face image of the pattern second layer is recognized from a value of brightness to be obtained with respect to the side face of the pattern second layer and the side-face image of the pattern is detected on the basis thereof.

Thus, the method of recognizing a pattern side face in accordance with the second preferred embodiment allows the auto defect review/classification system to automatically detect the pattern side face in the SEM image by storing the value of brightness to be obtained with respect to the images of respective portions of the pattern in the SEM image into the auto defect review/classification system.

<The Third Preferred Embodiment>

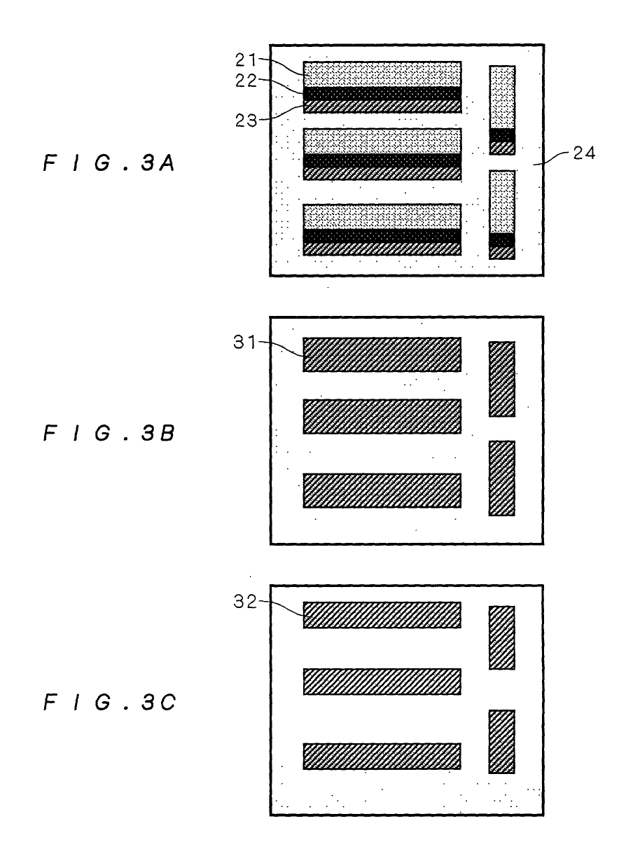

FIGS. 3A to 3C are views illustrating a method of recognizing a pattern side face in accordance with the third preferred embodiment of the present invention. Specifically, FIG. 3A shows an exemplary SEM image in a case where a wafer is reviewed by being tilted, and FIG. 3B shows CAD data of the same position in the wafer as shown in FIG. 3A. A region 31 in FIG. 3B corresponds to a pattern formation region on the wafer. FIG. 3C shows data after transforming the CAD data of FIG. 3B in accordance with the tilt angle of FIG. 3A. Further, in FIGS. 3A to 3C, the same constituent elements as those in FIG. 1D are represented by the same reference numerals and detailed description on these elements will be omitted herein. Furthermore, FIGS. 3A to 3C also show the case where the patterns each of which has double-layer structure consisting of the pattern top layer and the pattern second layer are formed on a surface of the wafer.

A method of recognizing a pattern side face in accordance with the third preferred embodiment will be discussed below. First, the auto defect review/classification system captures CAD data on the wafer to be reviewed. Then, the auto defect review/classification system obtains the SEM image (FIG. 3A) by review with the wafer tilted at a predetermined angle. Next, the auto defect review/classification system retrieves the CAD data (FIG. 3B) corresponding to a review point of the wafer and transforms the CAD data into the data as shown in FIG. 3C in accordance with the tilt angle of the wafer at the time when the SEM image (FIG. 3A) is obtained. For example, when the tilt angle of the wafer is 60 degrees, since the size of the upper-face image of the pattern top layer in the SEM image obtained by review with the wafer tilted in a direction of tilting the wafer is cos 60° of the size of the upper-face image of the pattern top layer in the review with the wafer not tilted, i.e., half thereof, the size in the direction of tilting the wafer in the CAD data is accordingly transformed into half.

Utilizing that the upper-face image 21 of the pattern top layer in the SEM image obtained by review with the wafer tilted and the pattern formation region 31 in the CAD data transformed in accordance with the tilt angle of the wafer coincide with each other in shape and position, the auto defect review/classification system can recognize that the image 21 should be the upper-face image of the pattern top layer by superimposing the transformed CAD data (FIG. 3C) on the SEM image (FIG. 3A) obtained by review with the wafer tilted.

With recognition of the upper-face image 21 of the pattern top layer on the SEM screen, the auto defect review/classification system can further recognize that the image 22 therebelow should be the side-face image of the pattern top layer. When the side-face image 22 of the pattern top layer is found, it is found that the side-face image of the pattern second layer should be the image 23 below the image 22 on the screen, like in the first preferred embodiment.

Further, though the third preferred embodiment shows the case where the pattern which has the double-layer structure consisting of the pattern top layer and the pattern second layer is formed as a pattern on the wafer to be reviewed, even in a pattern consisting of more layers, by finding the position of the upper face of the pattern top layer, it is possible to recognize side-face images of respective layers on the basis of the position. In other words, the application range of the third preferred embodiment is not limited to the pattern having the double-layer structure.

Thus, the method of recognizing a pattern side face in accordance with the third preferred embodiment allows the auto defect review/classification system to automatically detect the pattern side face by linking the auto defect review/classification system with CAD data.

<The Fourth Preferred Embodiment>

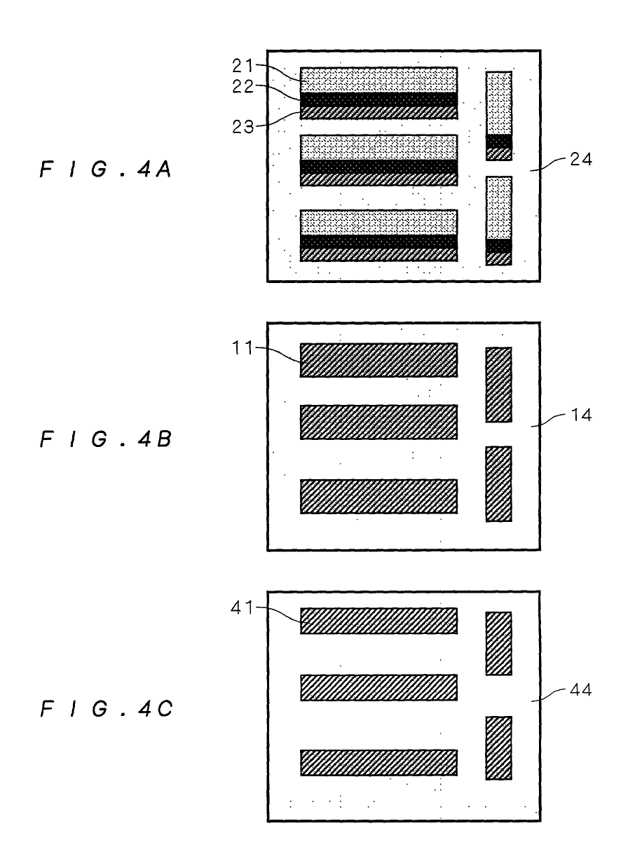

FIGS. 4A to 4C are views illustrating a method of recognizing a pattern side face in accordance with the fourth preferred embodiment of the present invention. Specifically, FIG. 4A shows an exemplary SEM image in a case where a wafer is reviewed by being tilted, FIG. 4B shows an SEM image of the same portion in the wafer in a case where the wafer is reviewed by not being tilted and FIG. 4C shows an SEM image after transforming the SEM image of FIG. 4B in accordance with the tilt angle of FIG. 4A. Further, in FIGS. 4A to 4C, the same constituent elements as those in FIG. 1D are represented by the same reference numerals and detailed description on these elements will be omitted herein. Furthermore, FIGS. 4A to 4C also show the case where the patterns each of which has double-layer structure consisting of the pattern top layer and the pattern second layer are formed on a surface of the wafer.

A method of recognizing a pattern side face in accordance with the fourth preferred embodiment will be discussed below. First, the auto defect review/classification system obtains the SEM image (FIG. 4A) of the wafer by review with the wafer tilted at a predetermined angle. Next, the auto defect review/classification system obtains the SEM image (FIG. 4B) by review with the wafer not tilted. Then, the auto defect review/classification system transforms the SEM image obtained by review with the wafer not tilted into the image as shown in FIG. 4C in accordance with the tilt angle of the wafer. For example, when the tilt angle of the wafer is 60 degrees, since the size of the upper-face image of the pattern top layer in the SEM image obtained by review with the wafer tilted in a direction of tilting the wafer is cos 60° of the size of the upper-face image of the pattern top layer in the review with the wafer not tilted, i.e., half thereof, the size of the SEM image obtained by review with the wafer not tilted in the direction of tilting the wafer is accordingly transformed into half.

Utilizing that the upper-face image 21 of the pattern top layer in the SEM image obtained by review with the wafer tilted and an upper-face image 41 of a pattern top layer in the SEM image transformed in accordance with the tilt angle of the wafer coincide with each other in shape and position, the auto defect review/classification system can recognize the upper face of the pattern top layer by superimposing the transformed SEM image obtained by review with the wafer not tilted (FIG. 4C) on the SEM image obtained by review with the wafer tilted (FIG. 4A).

With recognition of the upper-face image 21 of the pattern top layer on the SEM screen, the auto defect review/classification system can further recognize that the image 22 therebelow should be the side-face image of the pattern top layer. When the side-face image 22 of the pattern top layer is found, it is found that the side-face image of the pattern second layer should be the image 23 below the image 22 on the screen, like in the first preferred embodiment.

Further, though the fourth preferred embodiment shows the case where the pattern which has the double-layer structure consisting of the pattern top layer and the pattern second layer is formed as a pattern on the wafer to be reviewed, even in a pattern consisting of more layers, by finding the position of the upper face of the pattern top layer, it is possible to recognize side-face images of respective layers on the basis of the position. In other words, the application range of the fourth preferred embodiment is not limited to the pattern having the double-layer structure.

Thus, the method of recognizing a pattern side face in accordance with the fourth preferred embodiment allows the auto defect review/classification system to automatically detect the pattern side face without inputting the data for pattern detection to the auto defect review/classification system in advance since the SEM images obtained by reviews with the wafer tilted and not tilted are compared with each other to detect the pattern side face.

<The Fifth Preferred Embodiment>

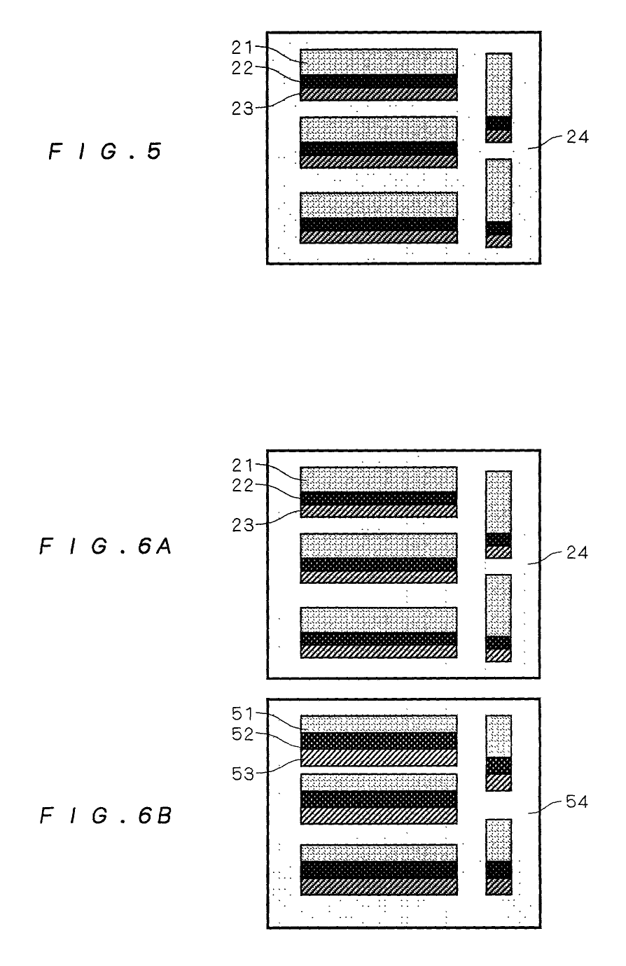

FIG. 5 is a view illustrating a method of recognizing a pattern side face in accordance with the fifth preferred embodiment of the present invention. FIG. 5 shows an exemplary SEM image obtained by review with a wafer tilted. In FIG. 5, the same constituent elements as those in FIG. 1D are represented by the same reference numerals and detailed description on these elements will be omitted herein. Further, FIG. 5 also shows the case where the patterns each of which has double-layer structure consisting of the pattern top layer and the pattern second layer are formed on a surface of the wafer.

As discussed above, the brightness of the SEM image depends on the amount of secondary electrons emitted from the sample and the amount of emitted secondary electrons depends on the angle of a sample to the electron beams of the SEM and the material of the sample. For example, when the tilt angle of the wafer increases within the range from 0° to 90°, since the incident angle of the electron beams to a pattern side face on the wafer decreases, the amount of secondary electrons emitted from the pattern side face decreases and the brightness of the image of the pattern side face in the SEM image is weaken. In contrast to this, since the incident angle of the electron beams to a pattern upper face increases, the brightness of the pattern upper face in the SEM image is intensified. In short, when the tilt angle of the wafer increases within the range from 0° to 90° in the case of FIG. 5, the brightness of the upper-face image 21 of the pattern top layer and the image 24 of the wafer surface is intensified and that of the side-face image 22 of the pattern top layer and the side-face image 23 of the pattern second layer is weaken.

In other words, the images of the pattern upper face and the pattern side face have difference in the way of variation in brightness of pattern images of the SEM image caused by changing the tilt angle of the wafer. This suggests that it is possible to recognize the pattern side face on the basis of the way of variation in brightness of the pattern images in the SEM image caused by changing the tile angle of the wafer.

A method of recognizing a pattern side face in accordance with the fifth preferred embodiment will be discussed below. First, the auto defect review/classification system obtains an SEM image (a first SEM image) by review with the wafer tilted at a predetermined angle. Next, the auto defect review/classification system obtains an SEM image (a second SEM image) by review with the wafer tilted at an angle changed from the tilt angle in the case of the first SEM image. Then, the auto defect review/classification system detects increase and decrease in brightness of the first and second SEM images, to recognize the pattern side face.

For example, if the tilt angle of the wafer ranges from 0° to 90° in the case of FIG. 5, when the tilt angle of the wafer for obtaining the second SEM image is larger than that for obtaining the first SEM image, it is possible to judge that a portion of the second SEM image whose brightness becomes weaker than the first SEM image (the images 22 and 23) should be an image of the pattern side face.

Further, among the images included in the portion whose brightness becomes weaker, the uppermost image 22 is recognized to be a side-face image of the pattern top layer. When the side-face image 22 of the pattern top layer is found, it is found that the side-face image of the pattern second layer should be the image 23 below the image 22 on the screen, like in the first preferred embodiment.

Though not problematic when the difference in tilt angle of the wafer between the first and second SEM images is small, when the tilt angle of the wafer is largely changed, there arises apprehension that it should become difficult to discriminate the brightness of the images from each other since not only the brightness but also the shapes and positions of the respective images in the SEM image are largely changed. In this case, such a problem can be avoided, for example, by repeatedly recognizing the images every time when a small change in tilt angle is given. Alternatively, the auto defect review/classification system detects the tilt angle of the wafer and the magnitude of change in tilt angle, to correct the changes in shape and position of the images on the basis thereof, thereby avoiding the above problem.

Further, though the fifth preferred embodiment shows the case where the pattern which has the double-layer structure consisting of the pattern top layer and the pattern second layer is formed as a pattern on the wafer to be reviewed, even in a pattern consisting of more layers, by finding the image of the pattern side face, it is possible to recognize side-face images of respective layers constituting the pattern on the basis thereof. In other words, the application range of the fifth preferred embodiment is not limited to the pattern having the double-layer structure.

The method of recognizing a pattern side face in accordance with the fifth preferred embodiment allows the auto defect review/classification system to automatically detect the pattern side face without inputting the data for pattern detection to the auto defect review/classification system in advance since the pattern side face is recognized by detecting increase and decrease in brightness of the images caused by variation in tilt angle of the wafer in obtaining the SEM image.

<The Sixth Preferred Embodiment>

FIGS. 6A and 6B are views illustrating a method of recognizing a pattern side face in accordance with the sixth preferred embodiment of the present invention. Specifically, FIG. 6A shows an exemplary SEM image obtained by review with the wafer tilted and FIG. 6B shows an SEM image obtained by review with the wafer tilted at an angle larger than that in the case of FIG. 6A. In FIGS. 6A and 6B, the same constituent elements as those in FIG. 1D are represented by the same reference numerals and detailed description on these elements will be omitted herein. Further, FIGS. 6A and 6B also show the case where the patterns each of which has double-layer structure consisting of the pattern top layer and the pattern second layer are formed on a surface of the wafer.

It is clear from FIGS. 6A and 6B that the size and shape of images appearing in the SEM image of the wafer depends on the tilt angle of the wafer. For example, when the tilt angle of the wafer increases within the range from 0° to 90°, the area of an image of the pattern side face in the SEM image becomes larger and that of an image of the pattern upper face becomes smaller. In short, when the tilt angle of the wafer increases within the range from 0° to 90° in the case of FIGS. 6A and 6B, the areas and the lengths in the direction of tilting the wafer of the upper-face image 21 of the pattern top layer and the image 24 of the wafer surface decrease and the areas and the lengths in the direction of tilting the wafer of the side-face image 22 of the pattern top layer and the side-face image 23 of the pattern second layer increase.

In other words, the images of the pattern upper face and the pattern side face have difference in the way of variation in area and length of pattern images in the SEM image caused by changing the tilt angle of the wafer. This suggests that it is possible to recognize the pattern side face on the basis of the way of variation in area and length of the pattern images in the SEM image.

A method of recognizing a pattern side face in accordance with the sixth preferred embodiment will be discussed below. First, the auto defect review/classification system obtains an SEM image (a first SEM image) by review with the wafer tilted at a predetermined angle. Next, the auto defect review/classification system obtains an SEM image (a second SEM image) by review with the wafer tilted at an angle changed from the tilt angle in the case of the first SEM image. Then, the auto defect review/classification system detects increase and decrease in area and length in the direction of tilting the wafer of the first and second SEM images, to recognize the pattern side face.

For example, if the tilt angle of the wafer ranges from 0° to 90° in the case of FIGS. 6A and 6B, when the tilt angle of the wafer for obtaining the second SEM image (FIG. 6B) is larger than that for obtaining the first SEM image (FIG. 6A), it is possible to judge that a portion of the second SEM image whose area and length in the direction of tilting the wafer become larger than those of the first SEM image (the images 22 and 23 and images 52 and 53) should be an image of the pattern side face.

Further, among the images included in the portion whose area and length in the direction of tilting the wafer become larger, the uppermost images 22 and 52 are recognized to be side-face images of the pattern top layer. When the side-face images 22 and 52 of the pattern top layer are found, it is found that the side-face images of the pattern second layer should be the images 23 and 53 below the images 22 and 52, respectively, on the screen, like in the first preferred embodiment.

Though not problematic when the difference in tilt angle of the wafer between the first and second SEM images is small, when the tilt angle of the wafer is largely changed, there arises apprehension that it should become difficult to discriminate the images from each other since not only the areas and lengths but also the positions of the respective images in the SEM image are largely changed. In this case, such a problem can be avoided, for example, by repeatedly recognizing the images every time when a small change in tilt angle is given. Alternatively, the auto defect review/classification system detects the tilt angle of the wafer and the magnitude of change in tilt angle, to correct the changes in position of the images on the basis thereof, thereby avoiding the above problem.

Further, though the sixth preferred embodiment shows the case where the pattern which has the double-layer structure consisting of the pattern top layer and the pattern second layer is formed as a pattern on the wafer to be reviewed, even in a pattern consisting of more layers, by finding the image of the pattern side face, it is possible to recognize side-face images of respective layers constituting the pattern on the basis thereof. In other words, the application range of the sixth preferred embodiment is not limited to the pattern having the double-layer structure.

The method of recognizing a pattern side face in accordance with the sixth preferred embodiment allows the auto defect review/classification system to automatically detect the pattern side face without inputting the data for pattern detection to the auto defect review/classification system in advance since the pattern side face is recognized by detecting increase and decrease in area and length of the images caused by variation in tilt angle of the wafer in obtaining the SEM image.

<The Seventh Preferred Embodiment>

As mentioned earlier, in order to increase yields in a process of manufacturing a semiconductor device and improve the process, it is important to know a process step in which a defect is developed in a pattern formed on a semiconductor wafer.

FIG. 7 illustrates a method of detecting and classifying defects in accordance with the seventh preferred embodiment of the present invention, which is an enlarged view showing the vicinity of a portion including a defect of an SEM image obtained by review with the wafer tilted. In FIG. 7, the same constituent elements as those in FIG. 1D are represented by the same reference numerals and detailed description on these elements will be omitted herein. Further, FIG. 7 also shows the case where the pattern which has double-layer structure consisting of the pattern top layer and the pattern second layer is formed on a surface of the wafer. In this case, a defect caused by an extraneous matter exists in the pattern second layer and deformations due to presence of the extraneous matter are found in an interface between the pattern second layer and the pattern top layer and the upper face of the pattern top layer. Furthermore, reference numeral 60 represents an image of the extraneous matter causing the defect.

A method of classifying defects in accordance with the seventh preferred embodiment will be discussed below. First, the auto defect review/classification system obtains an SEM image of the wafer by review with the wafer tilted at a predetermined angle. Then, the auto defect review/classification system recognizes images of pattern side faces in the SEM image by using a predetermined method (e.g., the methods of the first to sixth preferred embodiments as discussed above). Further, the auto defect review/classification system detects a line 61 of the upper face of the pattern top layer and a line 62 of the upper face of the pattern second layer which appear in the pattern side face of the SEM image.

Next, the auto defect review/classification system obtains lines 63 and 64 of the upper faces of these layers in the pattern, which should appear if no defect exists. For example, the lines 63 and 64 in the case of no defect can be obtained by extracting portions of straight line relative to lines of the upper faces of the respective layers in the actually-obtained SEM image and connecting lines of the same level among the extracted lines with straight lines. Alternatively, the lines 63 and 64 in the case of no defect can be extracted by comparison with the same portion of the adjacent chip.

Subsequently, a comparison is made between the lines 63 and 64 in the case of no defect and the lines 61 and 62 which actually appear on the SEM image, to detect any line not coincident, i.e., line deformed by the presence of extraneous matter. At this time, by judging which line is deformed, the position of layer including the defect is specified. For example, when the lines of the upper faces of the pattern top layer and the pattern second layer are deformed, it is specified that the position of defect should be in the pattern second layer. Further, when the line of the upper face of the pattern top layer is deformed and the line of the upper face of the pattern second layer is not deformed, it is specified that the defect should lie in the pattern top layer. In the case of FIG. 7, since the lines of the upper faces of the pattern top layer and the pattern second layer are deformed, the auto defect review/classification system recognizes that the position of defect should be in the pattern second layer. Further, it is possible to classify the defect by specifying the layer in the pattern of multilayer structure in which the defect lies. As a result, the auto defect review/classification system can specify a process step of the pattern formation process in which a defect is developed.

Thus, the method of classifying defects in accordance with the seventh preferred embodiment allows the auto defect review/classification system to specify a layer in which the defect lies and a process step in which the defect is developed in the case where the defect causes a deformation in the upper face of the layer.

<The Eighth Preferred Embodiment>

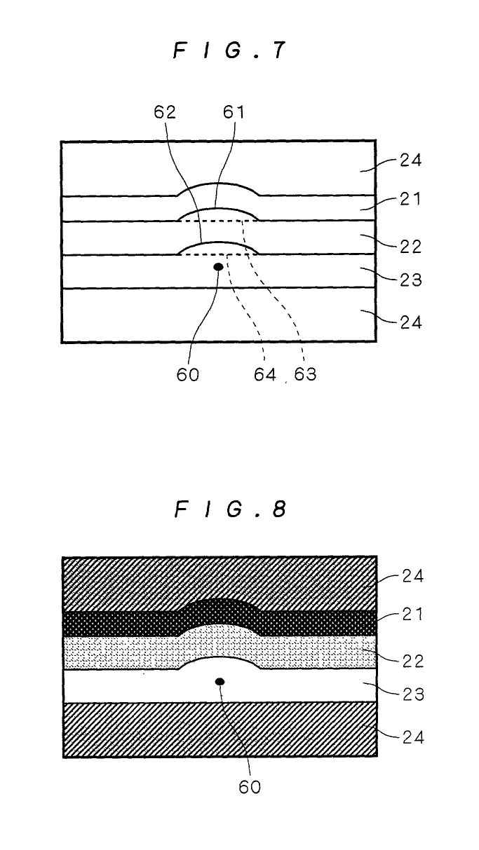

FIG. 8 illustrates a method of detecting and classifying defects in accordance with the eighth preferred embodiment of the present invention, which is an enlarged view showing the vicinity of a portion including a defect in an SEM image obtained by review with the wafer tilted. In FIG. 8, the same constituent elements as those in FIG. 7 are represented by the same reference numerals and detailed description on these elements will be omitted herein. Further, like in FIG. 7, in FIG. 8, the pattern which has double-layer structure consisting of the pattern top layer and the pattern second layer is formed on a surface of the wafer, and the defect caused by an extraneous matter exists in the pattern second layer and the deformations due to presence of the extraneous matter are found in the interface between the pattern second layer and the pattern top layer and the upper face of the pattern top layer. Furthermore, the extraneous matter itself is found in the SEM image.

A method of classifying defects in accordance with the eighth preferred embodiment will be discussed below. First, the auto defect review/classification system obtains an SEM image of the wafer by review with the wafer tilted at a predetermined angle. Then, the auto defect review/classification system recognizes the side-face image 22 of the pattern top layer and the side-face image 23 of the pattern second layer in the SEM image by using a predetermined method (e.g., the methods of the first to sixth preferred embodiments as discussed above).

As discussed above, the brightness of pattern images in the SEM image depends on the angle of a sample to the electron beams of the SEM and the material of the sample. For example, when an extraneous matter is exposed on a side face of a pattern and so on, an SEM image of the portion including the extraneous matter has a brightness different from that of the same portion on other chips.

In other words, by comparison in brightness of images in the same portions of adjacent chips, it is possible to recognize an image including a portion whose brightness does not coincide with that of images in the other chip (i.e., an image of defect) as an image including a defect. Further, since side-face images of respective layers of a pattern in the SEM image have already been recognized by the auto defect review/classification system, it is possible to judge which layer corresponds to the image including the defect. Therefore, with the defect review classification system, classification of defects can be performed by specifying a layer in the pattern of multilayer structure in which a defect lies. As a result, the auto defect review/classification system can specify a process step in the pattern formation process in which the defect is developed.

Furthermore, though FIG. 8 shows the case where the deformations due to presence of the extraneous matter are found in the interface between the pattern second layer and the pattern top layer and the upper face of the pattern top layer, it goes without saying that an image including a defect can be specified to detect and classify the defect only if the extraneous matter (defect) is detected as an image in the SEM image, even when the defect causes no deformation in shape of the upper face of the layer.

Thus, the method of classifying defects in accordance with the eighth preferred embodiment allows the auto defect review/classification system to specify a layer in which the defect lies and a process step in which the defect is developed even if the defect causes no deformation in the upper face of the layer since the deformation in shape of the images of the respective layers is not used for defect detection.

<The Ninth Preferred Embodiment>

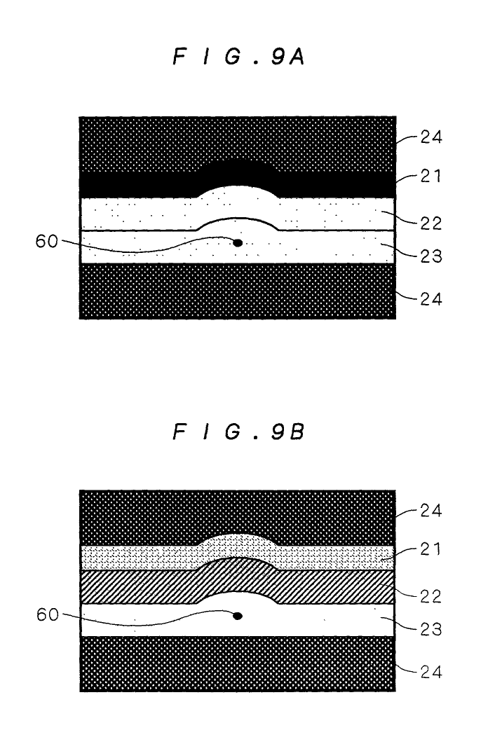

FIGS. 9A and 9B illustrate a method of recognizing a pattern side face in accordance with the ninth preferred embodiment of the present invention, which are enlarged views each showing the vicinity of a portion including a defect in an SEM image obtained by review with the wafer tilted. In FIGS. 9A and 9B, the same constituent elements as those in FIG. 7 are represented by the same reference numerals and detailed description on these elements will be omitted herein. Further, like in FIG. 7, in FIGS. 9A and 9B, the pattern which has double-layer structure consisting of the pattern top layer and the pattern second layer is formed on a surface of the wafer, and the defect caused by an extraneous matter exists in the pattern second layer and the deformations due to presence of the extraneous matter are found in the interface between the pattern second layer and the pattern top layer and the upper face of the pattern top layer.

Though recognition of the images of respective layers in the side-face image of the pattern is performed by using the methods of recognizing a pattern side face in the first to sixth preferred embodiments, the recognition can be made on the premise that the difference in brightness of the images of the respective layers is clear. There may be a case, however, where even if the layers are made of different materials, for example, the auto defect review/classification system can not discriminate the layers from one another because the images of the respective layers in the SEM image have approximate brightness.

Since the brightness of pattern images in the SEM image depends on the amount of secondary electrons emitted from a surface of a sample by irradiation of electron beams, the brightness of the image is changed depending on an accelerating voltage of the electron beams, even using the same sample, and the amount of variation in brightness depends on the material of the sample. Therefore, by changing the accelerating voltage of the electron beams of the SEM, it is possible to clarify the difference in brightness of images due to the material of the sample.

When the auto defect review/classification system can not discriminate the layers from one another because the images of the respective layers in the SEM image have approximate brightness though the surface of the wafer and the respective layers constituting the pattern are made of different materials, the ninth preferred embodiment changes the accelerating voltage of the electron beams of the SEM, to clarify the difference in brightness of the images of the respective layers.

It is assumed, for example, that when the pattern top layer and the pattern second layer are made of W (tungsten) and WSi (tungsten silicide), respectively, and the SEM image is obtained by irradiation of electron beams at an accelerating voltage of 1000 eV, the difference in brightness between the side-face image 22 of the pattern top layer and the side-face image 23 of the pattern second layer can not be detected, as shown in FIG. 9A. In this case, by changing the accelerating voltage into, e.g., 1500 eV, the difference in brightness of the images of the respective layers can be clarified in the SEM image in the same portion as shown in FIG. 9B, and the auto defect review/classification system can thereby discriminate the brightness of the images of the respective layers in the SEM image and recognize the side faces of the respective layers.

Thus, the method of classifying defects in accordance with the ninth preferred embodiment changes the accelerating voltage of the electron beams to clarify the difference in brightness of the images of the respective layers in the pattern side face due to the difference in material, allowing the auto defect review/classification system to perform the automatic recognition of the pattern side face as discussed in the first to sixth preferred embodiments with high accuracy.

<The Tenth Preferred Embodiment>

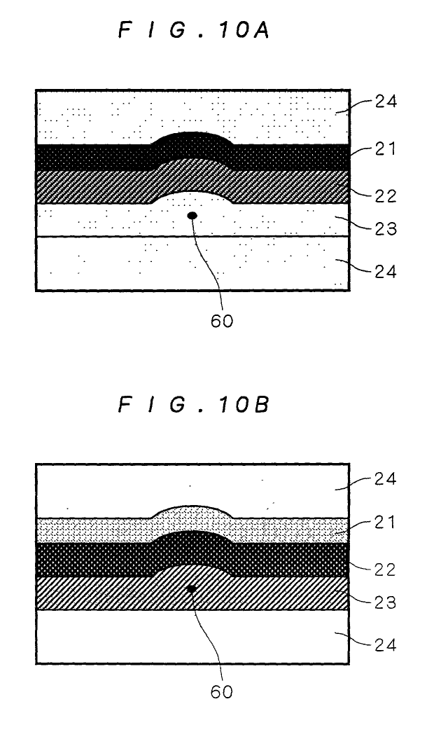

FIGS. 10A and 10B are views illustrating a method of recognizing a pattern side face in accordance with the tenth preferred embodiment of the present invention, which are enlarged views each showing the vicinity of a portion including a defect in an SEM image obtained by review with the wafer tilted. In FIGS. 10A and 10B, the same constituent elements as those in FIG. 7 are represented by the same reference numerals and detailed description on these elements will be omitted herein. Also in FIGS. 10A and 10B, the pattern which has double-layer structure consisting of the pattern top layer and the pattern second layer is formed on a surface of the wafer, and the defect caused by an extraneous matter exists in the pattern second layer and the deformations due to presence of the extraneous matter are found in the interface between the pattern second layer and the pattern top layer and the upper face of the pattern top layer.

Though recognition of the images of respective layers in the side-face image of the pattern is performed by using the methods of recognizing a pattern side face in the first to sixth preferred embodiments, the recognition can be made on the premise that the difference in brightness of the images of the respective layers is clear. There may be a case, however, where even if the layers are made of different materials, for example, the auto defect review/classification system can not discriminate the layers from one another because the images of the respective layers in the SEM image have approximate brightness.

The brightness of pattern images in the SEM image depends on the material of a sample and the angle of the sample to the electron beams. Therefore, even if samples made of different materials are used, images having the same brightness are sometimes obtained depending on the angles of the samples to the electron beams. For example, though the wafer surface and the pattern second layer are made of different materials, i.e., SiO₂ (silicon oxide) and WSi (tungsten silicide), respectively, the angles of the wafer surface and the pattern second layer to the electron beams are different from each other by 90°. Therefore, depending on the tilt angle of the wafer, the difference in brightness due to the material is offset by the difference in brightness due to the tilt angle, and the brightness of the side-face image 23 of the pattern second layer and that of the image 24 of the wafer surface become equal to each other as shown in FIG. 10A. In such a case, the auto defect review/classification system can not discriminate the side-face image 23 of the pattern second layer and the image 24 of the wafer surface by using the method of recognizing a pattern side face in accordance with the first to sixth preferred embodiments.

In such a case, the tenth preferred embodiment changes the tilt angle of the same wafer for obtaining the SEM image to change the brightness of the images of the respective layers in the SEM image, thereby clarifying the difference in brightness of these images. For example, as shown in FIG. 10A, when the brightness of the side-face image 23 of the pattern second layer and that of the image 24 of the wafer surface are equal to each other, increasing the tilt angle (0° to 90°) of the wafer weaken the brightness of the side-face image 23 of the pattern second layer and intensifies the image 24 of the wafer surface. As a result, as shown in FIG. 10B, in the SEM image of the same portion, the difference in brightness of the images of the respective layers becomes clear, and the auto defect review/classification system can thereby discriminate the brightness of the images of the respective layers in the SEM image and recognize the side faces of the respective layers.

Thus, the method of classifying defects in accordance with the tenth preferred embodiment changes the tilt angle of the wafer to clarify the difference in brightness of the images of the respective layers in the pattern side face due to the difference in material, allowing the auto defect review/classification system to perform the automatic recognition of the pattern side face as discussed in the first to sixth preferred embodiments with high accuracy.

While the invention has been shown and described in detail, the foregoing description is in all aspects illustrative and not restrictive. It is therefore understood that numerous modifications and variations can be devised without departing from the scope of the invention.

What is claimed is:

1. A method of recognizing a pattern side face, using an SEM image of a wafer which has a pattern of single-layer or multilayer structure in its surface, for recognizing a side-face image of each layer of said single-layer or multilayer structure in said SEM image, comprising the steps of:
obtaining an SEM image in a state where said wafer is tilted at a predetermined angle;
calculating the width of a side-face or upper-face image of a predetermined layer in said single-layer or multilayer structure to be found in said SEM image, from said predetermined angle and the thickness of a side face or the width of an upper face of said predetermined layer;
detecting an image having a width which corresponds to said calculated width in said SEM image to detect said side-face or upper-face image of said predetermined layer in said SEM image; and
recognizing a side-face image of each layer of said single-layer or multilayer structure in said SEM image on the basis of the position of said side-face or upper-face image of said predetermined layer which is detected.

2. The method of recognizing a pattern side face according to claim 1, further comprising the steps of changing an accelerating voltage of electron beams in an SEM to obtain an SEM image again when the difference in brightness of images of said wafer and layers of said single-layer or multilayer structure in said SEM image is not detected.

3. The method of recognizing a pattern side face according to claim 1, further comprising the steps of changing a tilt angle of said wafer to obtain an SEM image again when the difference in brightness of images of said wafer and layers of said single-layer or multilayer structure in said SEM image is not detected.

4. A method of detecting and classifying a defect, for detecting a defect in a pattern of single-layer or multilayer structure on a wafer and making a classification by specifying which one of layers in said pattern includes said defect, comprising the steps of:
obtaining an SEM image in a state where said wafer is tilted at a predetermined angle;
recognizing a side-face image of each layer of said single-layer or multilayer structure in said SEM image by using a predetermined method;
recognizing at least an upper contour of said recognized side-face image of each layer of said single-layer or multilayer structure; and
detecting deformation of said upper contour of said side-face image of each layer of said single-layer or multilayer structure to detect said defect and make a classification by specifying which one of layers in said pattern includes said defect.

5. The method of detecting and classifying a defect according to claim 4, wherein said predetermined method used in said step of recognizing a side-face image of each layer of said single-layer or multilayer structure in said SEM image comprises the steps of:
calculating the width of a side-face or upper-face image of a predetermined layer in said single-layer or multilayer structure to be found in said SEM image, from said predetermined angle and the thickness of a side face or the width of an upper face of said predetermined layer;
detecting an image having a width which corresponds to said calculated width in said SEM image to detect said side-face or upper-face image of said predetermined layer in said SEM image; and
recognizing a side-face image of each layer of said single-layer or multilayer structure in said SEM image on the basis of the position of said side-face or upper-face image of said predetermined layer which is detected.

6. A method of detecting and classifying a defect, for detecting a defect in a pattern of single-layer or multilayer structure on any chip of a wafer having a plurality of chips and making a classification by specifying which one of layers in said pattern includes said defect, comprising the steps of:
obtaining an SEM image in a state where said wafer is tilted at a predetermined angle;
recognizing a side-face image of each layer of said single-layer or multilayer structure in said SEM image by using a predetermined method; and
comparing the brightness of images of layers in said pattern of said plurality of chips in said SEM image to detect said defect and make a classification by specifying which one of layers in said pattern includes said defect.

7. The method of detecting and classifying a defect according to claim 6, wherein said predetermined method used in said step of recognizing a side-face image of each layer of said single-layer or multilayer structure in said SEM image comprises the steps of:
calculating the width of a side-face or upper-face image of a predetermined layer in said single-layer or multilayer structure to be found in said SEM image, from said predetermined angle and the thickness of a side face or the width of an upper face of said predetermined layer;
detecting an image having a width which corresponds to said calculated width in said SEM image to detect said side-face or upper-face image of said predetermined layer in said SEM image; and
recognizing a side-face image of each layer of said single-layer or multilayer structure in said SEM image on the basis of the position of said side-face or upper-face image of said predetermined layer which is detected.
